(19) United States
(12) Patent Application Publication
(10) Pub. No.: US 2025/0363184 A1
(43) Pub. Date: Nov. 27, 2025

(54) INFORMATION PROCESSING APPARATUS, INFORMATION PROCESSING METHOD, AND PROGRAM

(71) Applicant: NEC Corporation, Tokyo (JP)

(72) Inventor: Ryutaro DOI, Tokyo (JP)

(21) Appl. No.: 19/203,335

(22) Filed: May 9, 2025

(30) Foreign Application Priority Data
May 22, 2024 (JP) 2024-083258

(51) Int. Cl. G06F 17/11

(52) U.S. Cl. CPC G06F 17/11

(57) ABSTRACT

An information processing apparatus of the present disclosure includes: a selecting unit that selects at least one solver of a plurality of solvers that are set to solve a combinatorial optimization problem under different solution conditions, respectively; and an executing unit that executes a solution process by the selected solver and obtains an index for evaluating performance of the solver after the execution. The information processing apparatus repeatedly performs a series of processes that includes selecting the solver, executing the solution process by the selected solver and obtaining the index.

### INCORPORATION BY REFERENCE

This application is based upon and claims the benefit of priority from Japanese patent application No. 2024-083258, filed on May 22, 2024, the disclosure of which is incorporated herein in its entirety by reference.

### TECHNICAL FIELD

The present disclosure relates to an information processing apparatus, an information processing method, and a program.

### BACKGROUND ART

As a method for solving a combinatorial optimization problem, simulated annealing is known as described in Patent Literature 1. In simulated annealing, at the time of exploring the solution in an optimization problem, it always transitions to a neighborhood solution when the evaluation value of the neighborhood solution is good, and it may transition stochastically when the evaluation value of the neighborhood solution is bad. The probability at this time is determined by a set temperature parameter value.

At this time, when the temperature parameter is high, the probability of transition to a solution with a bad evaluation value is higher, and it can escape from a local solution, but it may move away from the optimal solution. When the temperature parameter is low, the probability of transition to a solution with a bad evaluation value is low, and it may converge to a neighborhood local solution and may not escape from the local solution. Therefore, it is expected to reach the optimal solution by solving while gradually lowering the temperature over a sufficiently long period of time by simulated annealing.

### CITATION LIST

### Patent Literature

[Patent Literature 1] WO2019/234837

### SUMMARY OF INVENTION

### Technical Problem

However, there is a need to perform simulated annealing in a finite amount of time when solving a combinatorial optimization problem in actual operation, and the accuracy of the final solution varies in accordance with an annealing condition such as the initial state of the solution and the temperature schedule. Therefore, there arises a problem that it is not possible to achieve further increase of the accuracy of solution in a combinatorial optimization problem.

Accordingly, an object of the present disclosure is to solve the abovementioned problem that it is not possible to achieve further increase of the accuracy of solution in a combinatorial optimization problem.

### Solution to Problem

An information processing apparatus as an aspect of the present disclosure includes: a selecting unit that selects at least one solver of a plurality of solvers that are set to solve a combinatorial optimization problem under different solution conditions, respectively; and an executing unit that executes a solution process by the selected solver and obtains an index for evaluating performance of the solver after the execution. The information processing apparatus repeatedly performs a series of processes that includes selecting the solver, executing the solution process by the selected solver and obtaining the index.

Further, an information processing method as an aspect of the present disclosure includes repeatedly performing a series of processes that includes: selecting at least one solver of a plurality of solvers that are set to solve a combinatorial optimization problem under different solution conditions, respectively; and executing a solution process by the selected solver and obtaining an index for evaluating performance of the solver after the execution.

Further, a program as an aspect of the present disclosure includes instructions for causing a computer to execute processes to repeatedly perform a series of processes that includes: selecting at least one solver of a plurality of solvers that are set to solve a combinatorial optimization problem under different solution conditions, respectively; and executing a solution process by the selected solver and obtaining an index for evaluating performance of the solver after the execution.

### Advantageous Effects of Invention

Configured as described above, the present disclosure can achieve further increase of the accuracy of solution in a combinatorial optimization problem.

### BRIEF DESCRIPTION OF DRAWINGS

FIG. 1 is a block diagram showing an example of a configuration of an information processing apparatus according to the present disclosure.

FIG. 2 is a diagram showing an example of a state of processing by the information processing apparatus according to the present disclosure.

FIG. 3 is a diagram showing an example of a state of processing by the information processing apparatus according to the present disclosure.

FIG. 4 is a flowchart showing an example of processing operation of the information processing apparatus according to the present disclosure.

FIG. 5 is a block diagram showing an example of a hardware configuration of an information processing apparatus according to the present disclosure.

FIG. 6 is a block diagram showing an example of a configuration of the information processing apparatus according to the present disclosure.

### Example Embodiments

### First Example Embodiment

A first example embodiment of the present disclosure will be described with reference to the drawings. The drawings may be related to any of the example embodiments.

An information processing apparatus in the present disclosure is used for preparing a plurality of annealers (hereinafter also referred to as “SA”) that are solvers for solving a preset combinatorial optimization problem, and selecting an annealer with good evaluation that can obtain a good solution. An exploration of the solution of a combinatorial optimization problem by an annealer is performed by exploring a solution in such a manner that energy is minimized by simulated annealing. Then, at the time of exploring the solution in simulated annealing, it always transitions when the evaluation value of a neighborhood solution is good, but it may transition stochastically even when the evaluation value of a neighborhood solution is bad, and the probability at this time is determined by a temperature parameter. Although it is expressed as a solver, it does not need to be a physical device, and may be expressed as a plurality of annealing methods or the like. That is to say, a solver in the present disclosure is a term referring to a method for exploring the solution of a combinatorial optimization problem.

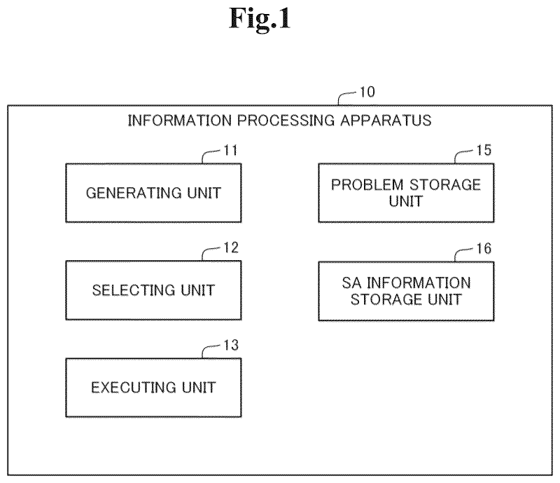

The information processing apparatus 10 is configured with one or a plurality of information processing apparatuses each including an arithmetic logic unit and a memory unit. Then, as shown in FIG. 1, the information processing apparatus 10 includes a generating unit 11, a selecting unit 12, and an executing unit 13. The respective functions of the generating unit 11, the selecting unit 12, and the executing unit 13 can be implemented by execution of a program for implementing the respective functions stored in the memory unit by the arithmetic logic unit. Moreover, the information processing apparatus 10 includes a problem storage unit 15 and an SA information storage unit 16 that are implemented by the memory unit. Hereinafter, the respective components and the operation will be described.

The problem storage unit 15 stores information representing a combinatorial optimization problem to be solved. For example, a traveling salesman problem is an example of a combinatorial optimization problem. A traveling salesman problem is an optimization problem to find a route with the shortest travel distance under a constraint condition that the salesman visits all the cities once given the distance between each pair of cities. However, a combinatorial optimization problem to be solved may be an optimization problem with any content.

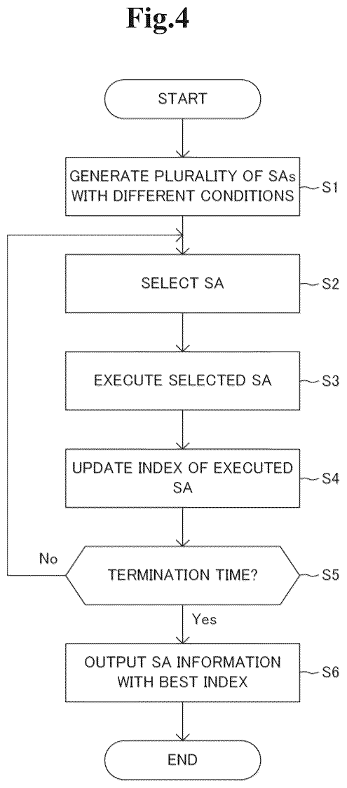

The generating unit 11 generates an annealer (SA), which is a solver that solves the combinatorial optimization problem, based on information of the combinatorial optimization problem as described above (step S1 of FIG. 4). At this time, the generating unit 11 generates annealers with different solution conditions. For example, the solution conditions include an initial state (initial solution) and a temperature schedule that specifies increase or decrease of the temperature. Therefore, the respective generated annealers have different solution exploration operations and different states after execution of a solution process. That is to say, the respective annealers have different values representing performance such as the evaluation value of the explored solution, the degree of constraint violation of the solution, and the degree of update of the solution, after execution of the solution process by simulated annealing for a predetermined period of time. In this example embodiment, the evaluation value of the solution after execution of the solution process by simulated annealing for a predetermined period of time by an annealer is treated as an index for evaluating the performance of the annealer. However, the index for evaluating the performance of the annealer is not limited to the evaluation value of the explored solution, and the degree of constraint violation (frequency and percentage) of the solution and the degree of update of the solution (frequency and percentage) described above and even a value related to execution of the solution process by the annealer may be used as the index for evaluating the performance of the annealer. Moreover, a value calculated based on a value such as the evaluation value of the solution described above and a value based on a combination of values such as the evaluation value of the solution described above and the like may be used as the index.

Each annealer generated by the generating unit 11 is obtained by, for example, transforming a constraint-based combinatorial optimization problem into a formulated model such as the Ising model and a Quadratic Unconstrained Binary Optimization (QUBO) model. Then, different solution conditions are set for the respective annealers as described above.

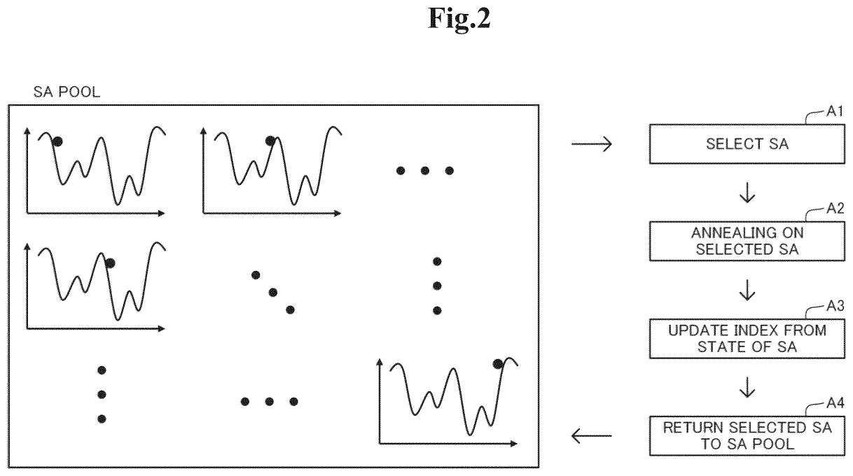

The generating unit 11 stores information of the generated annealers with different solution conditions into the SA information storage unit 16. An SA pool as shown in FIG. 2 is set in the SA information storage unit 16, and information of the generated annealers are stored in the SA pool. In FIG. 2, each graph represents each annealer itself and, for example, for each annealer, the solution condition as described above set in the annealer is stored as information of the annealer.

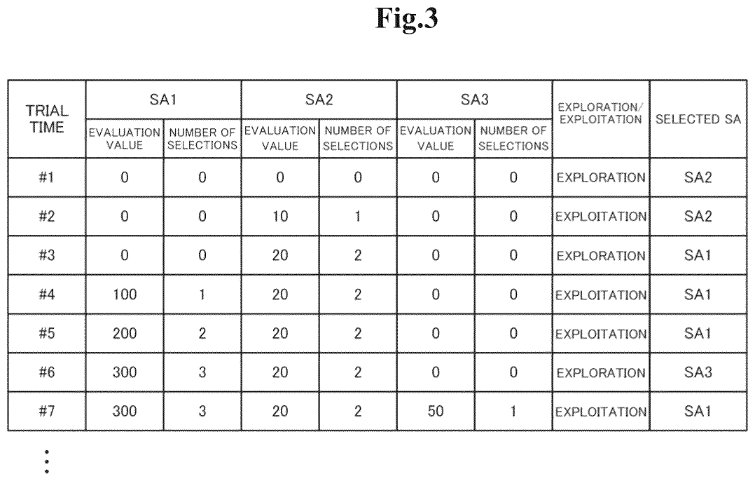

In addition to the information of each annealer itself, SA information, which is information generated as a result of the solution process by the annealer is stored in the SA information storage unit 16. FIG. 3 shows an example of the SA information stored in the SA information storage unit 16. In this example, assuming that three annealers SA1, SA2, and SA3 are stored in the SA pool, the identification information of each of the annealers is stored. Then, as will be described later, the information processing apparatus 10 repeatedly performs a series of processes including selecting an annealer and executing a solution process and, as the SA information, the identification information (#1, #2, . . . ) of a “trial time” of the series of processes is stored, and the “evaluation value” and the “number of selections” of each annealer by the series of processes in each trial time are stored as shown in FIG. 3. The “evaluation value” is an evaluation value (index) of a solution of each annealer after execution of the series of processes as described above. The “number of selections” is the cumulative number of times each annealer is selected in the series of processes so far.

Further, in the SA information storage unit 16, as the SA information, an action at the time of selecting an annealer during the series of processes in each trial time is expressed “exploration” or “exploitation” and stored as shown in FIG. 3. Here, the “exploration action” represents an action to randomly select an annealer from within the SA pool, and the “exploitation action” represents an action to select an annealer based on the value of an index that is the evaluation value of the annealer from within the SA pool. In addition, the identification information of the annealer selected during the series of processes in each trial time is stored as the SA information. A specific action to select an annealer will be described later.

Here, information of a plurality of annealers with different solution conditions as described above may be stored in advance in the SA pool of the SA information storage unit 16. That is to say, the generating unit 11 does not necessarily need to generate a plurality of annealers, and a plurality of annealers generated by another apparatus and information of a plurality of annealers prepared in advance may be stored in the SA pool.

Next, the selecting unit 12 and the executing unit 13 will be described. The selecting unit 12 and the executing unit 13 repeatedly perform a series of processes including selecting an annealer from within the SA pool and executing a solution process by the selected annealer. FIG. 2 shows the overview of the state of the series of processes by the selecting unit 12 and the executing unit 13. As shown in this view, the selecting unit 12 and the executing unit 13 repeatedly perform a plurality of trial times a series of processes including selecting an annealer (SA) from within the SA pool (reference sign A1), performing a solution process for a predetermined period of time on the selected annealer (reference sign A2), obtaining an index that is an evaluation value from the state of the annealer after execution of the solution process and updating and storing the index (reference sign A3), and returning the selected annealer to the SA pool (reference sign A4). Hereinafter, the processes by the selecting unit 12 and the executing unit 13 will be described specifically.

The selecting unit 12 selects at least one annealer from within the SA pool in each trial time of the series of processes described above (step S2 of FIG. 4). At this time, the selecting unit 12 selects an annealer in accordance with a selection action set in each trial time. As an example, the selection action includes an “exploration action” and an “exploitation action”. In the “exploration action”, an annealer is randomly selected from within the SA pool. In the “exploitation action”, an annealer is selected based on the value of an index that is an evaluation value of the annealer from within the SA pool. As an example, in the “exploitation action”, an annealer with the best index that is the evaluation value in each trial time is selected.

Here, in this example embodiment, for the selecting unit 12, the “exploration action” is set with a preset probability p and the “exploitation action” is set with a probability (1—p) in each trial time of the series of processes. As an example, in the case of probability p=0.5, it may occur that the “exploration action” is set and an annealer is randomly selected in the first trial time and the “exploitation action” is set and an annealer with the best index is selected in the second trial time. The probability p may be any value, and may be either a fixed value or a variable value. As an example of a case where the probability p is a variable value, in earlier trial times, the probability p is set to a larger value and the random annealer selection by the “exploration action” is performed more, and as the trial time increases, the probability p is set to a smaller value and the selection of an annealer with a higher index value by the “exploitation action” is performed more.

When selecting an annealer in each trial time, the selecting unit 12 may select one annealer, or may select a plurality of annealers. In the case of selecting a plurality of annealers, the selecting unit 12 may select a preset number of annealers in descending order of index in the “exploitation action”.

In each trial time of the series of processes, the executing unit 13 executes a solution process by the annealer selected as described above in the trial time (step S3 of FIG. 4). At this time, the executing unit 13 executes a solution process by the selected annealer for a predetermined period of time set in advance. In a case where a plurality of annealers are selected by the selecting unit 12, the executing unit 13 may execute the solution process by each of the annealers in order, or may execute in parallel.

Then, the executing unit 13 obtains an “evaluation value” of the solution, which is an index of the performance of the annealer after execution of the solution process, and updates and stores the value of the evaluation value as the SA information of the corresponding annealer in the SA information storage unit 16 (e.g., “evaluation value” field in FIG. 3). As the evaluation value of an annealer, a degree that it can increase after execution of the solution process may be set in advance for each annealer, and the value of the degree that it can increase is added to the previous evaluation value every time one trial is performed and the evaluation value may be updated. However, the evaluation value of the annealer may be calculated from the solution explored by the actually executed annealer, and may be calculated based on any criterion.

Further, the executing unit 13 stores other SA information in the SA information storage unit 16 every time the solution process in each trial time is performed. For example, the executing unit 13 associates, with information identifying the trial time (e.g., “#1” in FIG. 3), information of “exploration” or “exploitation” that is the set selection action, identification information of the selected annealer (e.g., “selected SA” field in FIG. 3) and the cumulative “number of selections” of the annealer, and stores as the SA information. However, part of the SA information may be stored by the selecting unit 12 described above.

Then, the selecting unit 12 and the executing unit 13 repeatedly perform the abovementioned series of processes over a plurality of trial times. At this time, for example, the selecting unit 12 and the executing unit 13 repeat the series of processes until a termination condition such that a preset termination time passes (No in step S5 of FIG. 4). The selecting unit 12 and the executing unit 13 stop the repetition of the series of processes when the preset termination time passes and the termination condition is satisfied (Yes in step S5 of FIG. 4). Then, the executing unit 13 outputs information of the annealer with the best “evaluation value” in the SA information storage unit 16 (step S6 of FIG. 4). For example, the executing unit 13 outputs the SA information such as the identification information of the annealer and the value of the evaluation value at that time.

Here, with reference to FIG. 3, an example of the state of specific processing by the selecting unit 12 and the executing unit 13 described above will be described. This example shows a case where three annealers SA1, SA2, and SA3 are stored in the SA pool as described above and the series of processes is executed in each of trial times #1 to #7. Moreover, in this example, in the selecting unit 12, the “exploration action” is set with a probability p=0.5 and the “exploitation action” is set with a probability (1—p) for each trial time, and one annealer is selected. Furthermore, in this example, the degree of increase in the evaluation value of each annealer by execution of the solution process in one trial time is set in advance and, for example, the evaluation value is added by the value “+100” for the annealer “SA1”, “+10” for the annealer “SA2”, and “+50” for the annealer “SA3”.

First, in the first trial time (#1), the selected action is set to “exploration action”, and the selecting unit 12 randomly selects an annealer from within the SA pool. At this time, it is assumed that an annealer “SA2” is selected. Then, the executing unit 13 executes the solution process by the selected annealer “SA2” and updates the SA information such as the evaluation value. Consequently, in the SA information field of the second trial time (#2), which is the next trial time, the “evaluation value” of the annealer “SA2” is updated to “10” and the “number of selections” is updated to “1”.

Subsequently, in the second trial time (#2), the selected action is set to “exploitation action”, and the selecting unit 12 selects an annealer with the highest evaluation value from within the SA pool. Then, an annealer “SA2” is selected. Then, the executing unit 13 executes the solution process by the selected annealer “SA2” and updates the SA information such as the evaluation value. Consequently, in the SA information field of the third trial time (#3), which is the next trial time, the “evaluation value” of the annealer “SA2” is updated to “20” and the “number of selections” is updated to “2”.

Subsequently, in the third trial time (#3), the selected action is set to “exploration action”, and the selecting unit 12 randomly selects an annealer from within the SA pool. At this time, it is assumed that an annealer “SA1” is selected. Then, the executing unit 13 executes the solution process by the selected annealer “SA1” and updates the SA information such as the evaluation value. Consequently, in the SA information field of the fourth trial time (#4), which is the next trial time, the “evaluation value” of the annealer “SA1” is updated to “100” and the “number of selections” is updated to “1”.

Subsequently, in the fourth trial time (#4), the selected action is set to “exploitation action”, and the selecting unit 12 selects an annealer with the highest evaluation value from within the SA pool. Then, the annealer “SA1” is selected. Then, the executing unit 13 executes the solution process by the selected annealer “SA1” and updates the SA information such as the evaluation value. Consequently, in the SA information field of the fifth trial time (#5), which is the next trial time, the “evaluation value” of the annealer “SA1” is updated to “200” and the “number of selections” is updated to “2”.

Subsequently, in the fifth trial time (#5), the selected action is set to “exploitation action”, and the selecting unit 12 selects an annealer with the highest evaluation value from within the SA pool. Then, the annealer “SA1” is selected. Then, the executing unit 13 executes the solution process by the selected annealer “SA1” and updates the SA information such as the evaluation value. Consequently, in the SA information field of the sixth trial time (#6), which is the next trial time, the “evaluation value” of the annealer “SA1” is updated to “300” and the “number of selections” is updated to “3”.

Subsequently, in the sixth trial time (#6), the selected action is set to “exploration action”, and the selecting unit 12 randomly selects an annealer from within the SA pool. At this time, it is assumed that the annealer “SA3” is selected. Then, the executing unit 13 executes the solution process by the selected annealer “SA3” and updates the SA information such as the evaluation value. Consequently, in the SA information field of the seventh trial time (#7), which is the next trial time, the “evaluation value” of the annealer “SA3” is updated to “50” and the “number of selections” is updated to “1”.

Then, when a termination condition such that a preset termination time passes is satisfied, the executing unit 13 examines the SA information in the SA information storage unit 16 and outputs the information of an annealer with the best “evaluation value”. For example, in the SA information of the seventh trial time (#7) shown in FIG. 3, the evaluation value of the annealer “SA1” is the best, so that the executing unit outputs information such as the identification information identifying the annealer “″SA1”.

Consequently, when solving a combinatorial optimization problem, it is possible to obtain the information of the annealer “SA1” with the best evaluation value. Then, it is possible to intensively allocate resources on such an annealer and use the annealer for the solution process. As a result, it is possible to achieve further increase of the accuracy of solution in a combinatorial optimization problem.

Here, in the example of FIG. 3 described above, the selected action by the selecting unit 12 is set alternately to “exploration action” and “exploitation action” every time the series of processes is performed once or a plurality of times. Consequently, each annealer is selected and the solution process is performed, so that every annealer can be evaluated.

In a case where the selecting unit 12 selects an annealer at random in the “exploration action”, the selecting unit 12 may select an annealer completely at random, or may select an annealer by another method. For example, in the “exploration action”, the selecting unit 12 may select an annealer in accordance with a selection probability sᵢ weighted by the value of an index such as the evaluation value stored in association with each annealer. At this time, the selection probability sᵢ can be calculated by, for example, Formula 1 shown below.

$${s}_{i} = \frac{exp ( {e}_{j} / α )}{{\sum }_{j} exp ( {e}_{j} / α )} \qquad [ Formula 1 ]$$

In Formula 1 shown above, eᵢ is the value of an index of an ith annealer (e.g., an evaluation value), and α is a bias parameter of a fixed value or a variable value.

Consequently, each annealer is randomly selected and the solution process is performed while considering the index of the annealer, so that every annealer can be evaluated.

Further, in the “exploration action”, the selecting unit 12 may select an annealer based on the number of selections of each annealer. For example, the selecting unit 12 may repeatedly perform a series of processes while selecting each annealer at least once in the “exploration action”. As an example, in each trial time, the selecting unit 12 may first in priority select all the annealers once for each and perform the series of processes repeatedly, and then further perform the series of processes repeatedly. At this time, after selecting all the annealers once for each and performing the series of processes repeatedly, the selecting unit may select one or more annealers in decreasing order of score expressed by Formula 2 shown below.

$${e}_{i} + β \times \sqrt{\frac{log ( {n}_{sum} )}{{n}_{i}}} \qquad [ Formula 2 ]$$

In Formula 2 shown above, eᵢ is the value of the index of an ith annealer (e.g., evaluation value), β is an exploration positiveness parameter of a fixed value or a variable value, nₛᵤₘ is the total selection count of all the annealers, and nᵢ is the number of selections of the ith annealer.

Consequently, an annealer with a small number of selections is positively selected and the solution process is performed, so that every annealer can be evaluated. The selecting unit 12 may select an annealer based on the score of only Formula 2, or may select an annealer in accordance with a criterion based on the number of selections.

The generating unit 11 described above may generate a new annealer and add and store it into the SA pool in the middle of performing the series of processes repeatedly by the selecting unit 12 and the executing unit 13. Consequently, the newly added annealer is also selected and the solution process is performed, so that every annealer can be evaluated.

### Second Example Embodiment

Next, a second example embodiment of the present disclosure will be described with reference to the drawings. In this example embodiment, the overview of the information processing apparatus and so forth described in the above example embodiment is shown. The drawings may be related to any of the example embodiments.

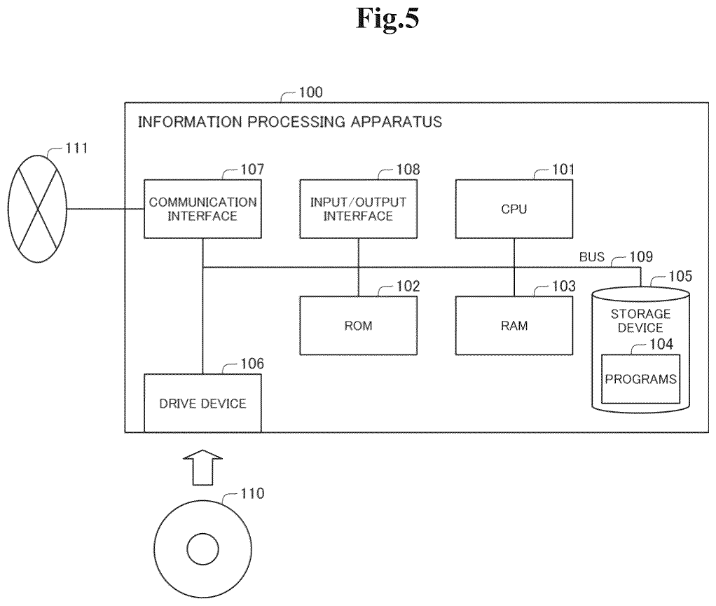

First, a hardware configuration of an information processing apparatus 100 in the present disclosure will be described. The information processing apparatus 100 is configured with a general information processing apparatus and, as an example, as shown in FIG. 5, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 5 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

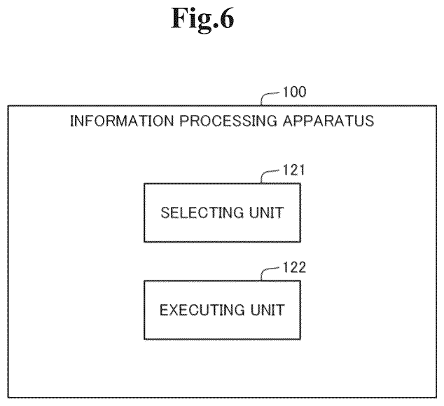

Then, the information processing apparatus 100 can construct and include a selecting unit 121 and an executing unit 122 shown in FIG. 6 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the selecting unit 121 and the executing unit 122 described above may be constructed using a dedicated electronic circuit for implementing such means.

The abovementioned selecting unit 121 selects at least one solver of a plurality of solvers set to solve a combinatorial optimization problem under different solution conditions. The abovementioned executing unit 122 executes a solution process by the selected solver and obtains an index for evaluating the performance of the solver after the execution. Then, a series of processes including selecting the solver and executing the solution process by the selected solver to obtain the index is repeatedly performed.

With the above configuration, the present disclosure can evaluate every annealer, and achieve further increase of the accuracy of solution in a combinatorial optimization problem.

At least one or more functions of the functions of the selecting unit 121 and the executing unit 122 described above may be executed by an information processing apparatus installed and connected anywhere on a network, that is, may be executed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### Supplementary Notes

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configurations described in the following supplementary notes.

All or some of the configurations described in Supplementary Notes 2 to 8.3 dependent on Supplementary Note 1 described above and the functions by such configurations may be dependent on other Supplementary Notes 9 and 10 by the same dependence as Supplementary Notes 2 to 8.3. Furthermore, not limited to Supplementary Notes 1, 9 and 10, within the scope of the example embodiments described above, all or some of the configurations described as supplementary notes and functions by such configurations may be dependent on hardware, software, various recording means for recording software, or system.

### (Supplementary Note 1)

An information processing apparatus comprising:
a selecting unit that selects at least one solver of a plurality of solvers that are set to solve a combinatorial optimization problem under different solution conditions, respectively; and
an executing unit that executes a solution process by the selected solver and obtains an index for evaluating performance of the solver after the execution,
wherein a series of processes is repeatedly performed that includes selecting the solver, executing the solution process by the selected solver and obtaining the index.

### (Supplementary Note 2)

The information processing apparatus according to supplementary note 1, wherein:
when the series of processes is repeatedly performed, the executing unit updates and stores the index of the solver obtained by executing the solution process; and
after the series of processes is repeatedly performed in such a manner as to satisfy a preset condition, the executing unit outputs information of the solver based on the index.

### (Supplementary Note 2.1)

The information processing apparatus according to supplementary note 2, wherein
after the series of processes is repeatedly performed in such a manner as to satisfy the preset condition, the executing unit outputs information of the solver corresponding to the index that is optimal according to a preset criterion.

### (Supplementary Note 3)

The information processing apparatus according to supplementary note 1, wherein
when the series of processes is repeatedly performed, the selecting unit selects the solver at random.

### (Supplementary Note 4)

The information processing apparatus according to supplementary note 3, wherein
when the series of processes is repeatedly performed, the selecting unit selects the solver with a probability based on a value of the index.

### (Supplementary Note 5)

The information processing apparatus according to supplementary note 1, wherein
when the series of processes is repeatedly performed, the selecting unit selects the solver at random and selects the solver based on a value of the index.

### (Supplementary Note 6)

The information processing apparatus according to supplementary note 5, wherein
when the series of processes is repeatedly performed, every time the series of processes is performed one time or a plurality of times, the selecting unit switches the selecting the solver at random and the selecting the solver based on the value of the index.

### (Supplementary Note 7)

The information processing apparatus according to supplementary note 1, wherein
when the series of processes is repeatedly performed, the selecting unit selects the solver based on a number of times that the solver is selected.

### (Supplementary Note 8)

The information processing apparatus according to supplementary note 7, wherein
when the series of processes is repeatedly performed, the selecting unit selects all the solvers at least one time.

### (Supplementary Note 8.1)

The information processing apparatus according to supplementary note 1, wherein
when the series of processes is repeatedly performed, the executing unit obtains, as the index, a value based on an evaluation value of a solution by the solver executing the solution process.

### (Supplementary Note 8.2)

The information processing apparatus according to supplementary note 1, wherein
when the series of processes is repeatedly performed, the executing unit obtains, as the index, a value based on a degree of constraint violation of a solution by the solver executing the solution process.

### (Supplementary Note 8.3)

The information processing apparatus according to supplementary note 1, wherein
when the series of processes is repeatedly performed, the executing unit obtains, as the index, a value based on a degree of update of a solution by the solver executing the solution process.

### (Supplementary Note 9)

An information processing method comprising
repeatedly performing a series of processes that includes:
selecting at least one solver of a plurality of solvers that are set to solve a combinatorial optimization problem under different solution conditions, respectively; and
executing a solution process by the selected solver and obtaining an index for evaluating performance of the solver after the execution.

### (Supplementary Note 9.1)

The information processing method according to supplementary note 9, comprising:
when repeatedly performing the series of processes, updating and storing the index of the solver obtained by executing the solution process; and
after repeatedly performing the series of processes in such a manner as to satisfy a preset condition, outputting information of the solver based on the index.

### (Supplementary Note 9.2)

The information processing method according to supplementary note 9, comprising
when repeatedly performing the series of processes, selecting the solver at random.

### (Supplementary Note 9.3)

The information processing method according to supplementary note 9, comprising
when repeatedly performing the series of processes, selecting the solver at random and selecting the solver based on a value of the index.

### (Supplementary Note 9.4)

The information processing method according to supplementary note 9.3, comprising
when repeatedly performing the series of processes, every time performing the series of processes one time or a plurality of times, switching the selecting the solver at random and the selecting the solver based on the value of the index.

### (Supplementary Note 9.5)

The information processing method according to supplementary note 9, comprising
when repeatedly performing the series of processes, selecting the solver based on a number of times that the solver is selected.

### (Supplementary Note 9.6)

The information processing method according to supplementary note 9.5, comprising
when repeatedly performing the series of processes, selecting all the solvers at least one time

### (Supplementary Note 10)

A program comprising instructions for causing a computer to execute processes to
repeatedly perform a series of processes that includes:
selecting at least one solver of a plurality of solvers that are set to solve a combinatorial optimization problem under different solution conditions, respectively; and
executing a solution process by the selected solver and obtaining an index for evaluating performance of the solver after the execution.

### REFERENCE SIGNS LIST

10 information processing apparatus
11 generating unit
12 selecting unit
13 executing unit
15 problem storage unit
16 SA information storage unit
100 information processing apparatus
101 CPU
102 ROM
103 RAM
104 programs
105 storage device
106 drive device
107 communication interface
108 input/output interface
109 bus
110 storage medium
111 communication network
121 selecting unit
122 executing unit

1. An information processing apparatus comprising:
at least one memory storing processing instructions; and
at least one processor configured to execute the processing instructions to:
select at least one solver of a plurality of solvers that are set to solve a combinatorial optimization problem under different solution conditions, respectively; and
execute a solution process by the selected solver and obtain an index for evaluating performance of the solver after the execution,
wherein the at least one processor is further configured to execute the processing instructions to repeatedly perform a series of processes that includes selecting the solver, executing the solution process by the selected solver, and obtaining the index.

2. The information processing apparatus according to claim 1, wherein the at least one processor is configured to execute the processing instructions to:
when repeatedly performing the series of processes, update and store the index of the solver obtained by executing the solution process; and
after repeatedly performing the series of processes in such a manner as to satisfy a preset condition, output information of the solver based on the index.

3. The information processing apparatus according to claim 2, wherein the at least one processor is configured to execute the processing instructions to
after repeatedly performing the series of processes in such a manner as to satisfy the preset condition, output information of the solver corresponding to the index that is optimal according to a preset criterion.

4. The information processing apparatus according to claim 1, wherein the at least one processor is configured to execute the processing instructions to
when repeatedly performing the series of processes, select the solver at random.

5. The information processing apparatus according to claim 4, wherein the at least one processor is configured to execute the processing instructions to
when repeatedly performing the series of processes, select the solver with a probability based on a value of the index.

6. The information processing apparatus according to claim 1, wherein the at least one processor is configured to execute the processing instructions to
when repeatedly performing the series of processes, select the solver at random and selecting the solver based on a value of the index.

7. The information processing apparatus according to claim 6, wherein the at least one processor is configured to execute the processing instructions to
when repeatedly performing the series of processes, every time performing the series of processes one time or a plurality of times, switch the selecting the solver at random and the selecting the solver based on the value of the index.

8. The information processing apparatus according to claim 1, wherein the at least one processor is configured to execute the processing instructions to
when repeatedly performing the series of processes, select the solver based on a number of times that the solver is selected.

9. The information processing apparatus according to claim 8, wherein the at least one processor is configured to execute the processing instructions to
when repeatedly performing the series of processes, select all the solvers at least one time.

10. The information processing apparatus according to claim 1, wherein the at least one processor is configured to execute the processing instructions to
when repeatedly perform the series of processes, obtain a value based on an evaluation value of a solution by the solver executing the solution process, as the index.

11. The information processing apparatus according to claim 1, wherein the at least one processor is configured to execute the processing instructions to
when repeatedly performing the series of processes, obtain a value based on a degree of constraint violation of a solution by the solver executing the solution process, as the index.

12. The information processing apparatus according to claim 1, wherein the at least one processor is configured to execute the processing instructions to
when repeatedly performing the series of processes, obtain a value based on a degree of update of a solution by the solver executing the solution process, as the index.

13. An information processing method comprising repeatedly performing a series of processes that includes:
selecting at least one solver of a plurality of solvers that are set to solve a combinatorial optimization problem under different solution conditions, respectively; and
executing a solution process by the selected solver and obtaining an index for evaluating performance of the solver after the execution.

14. The information processing method according to claim 13, comprising:
when repeatedly performing the series of processes, updating and storing the index of the solver obtained by executing the solution process; and
after repeatedly performing the series of processes in such a manner as to satisfy a preset condition, outputting information of the solver based on the index.

15. The information processing method according to claim 13, comprising
when repeatedly performing the series of processes, selecting the solver at random.

16. The information processing method according to claim 13, comprising
when repeatedly performing the series of processes, selecting the solver at random and selecting the solver based on a value of the index.

17. The information processing method according to claim 16, comprising
when repeatedly performing the series of processes, every time performing the series of processes one time or a plurality of times, switching the selecting the solver at random and the selecting the solver based on the value of the index.

18. The information processing method according to claim 13, comprising
when repeatedly performing the series of processes, selecting the solver based on a number of times that the solver is selected.

19. The information processing method according to claim 18, comprising
when repeatedly performing the series of processes, selecting all the solvers at least one time.

20. A non-transitory computer-readable storage medium storing a program, the program comprising instructions for causing a computer to execute processes to
repeatedly perform a series of processes that includes:
selecting at least one solver of a plurality of solvers that are set to solve a combinatorial optimization problem under different solution conditions, respectively; and
executing a solution process by the selected solver and obtaining an index for evaluating performance of the solver after the execution.
